(19) United States
(12) Patent Application Publication
(10) Pub. No.: US 2025/0296840 A1
(43) Pub. Date: Sep. 25, 2025

(54) SOLID ELECTROLYTE PRODUCTION PROCESS USING CARBON-FREE LIQUID

(71) Applicant: Solid Power Operating, Inc., Louisville, CO (US)

(72) Inventors: Clint R. BICKMORE, Louisville, CO (US); Brian E. FRANCISCO, Arvada, CO (US); Samuel M. OBERWETTER, Lafayette, CO (US); Benjamin A. CARLSON, St. Paul, MN (US)

(21) Appl. No.: 19/088,836

(22) Filed: Mar. 24, 2025

Related U.S. Application Data
(60) Provisional application No. 63/568,689, filed on Mar. 22, 2024.

(51) Int. Cl. C01B 17/22

(52) U.S. Cl. CPC C01B 17/22; C01P 2006/40

(57) ABSTRACT

Systems and methods using a plasma source and molten sulfur produce a homogeneous mixture of reactants and powder product devoid of a carbon residue. The systems and methods are used to form materials for use in a solid-state electrochemical cell without using organic solvents, which may form a chemical residue or may carbonize during high-temperature heat treatment.

### CROSS-REFERENCE TO RELATED APPLICATION

This application is related to and claims priority under 35 U.S.C. § 119 (e) to U.S. Patent Application No. 63/568,689, filed Mar. 22, 2024, titled “SOLID ELECTROLYTE PRODUCTION PROCESS USING CARBON-FREE LIQUID,” the entire contents of which is incorporated herein by reference for all purposes.

### FIELD OF THE DISCLOSURE

The present disclosure is related to systems and methods for making solid electrolyte materials.

### Background and Introduction

Standard techniques employed to produce solid-state electrolyte materials involve mixing, grinding or dissolution of precursor material in one or more organic solvents. The organic solvents are then removed by evaporation where the resulting dried materials are then subjected to a high temperature heat treatment. Using these organic solvents aids in producing homogenous mixtures of the precursor materials which, in turn, increases the chance of producing a single-phase solid electrolyte material. When precursor materials are mixed without using an organic solvent, the precursor materials may not be homogenously mixed. When the non-homogenous mixture is heated to a high temperature, the resulting product may contain heterogeneities and may not have had the correct ratio of precursors to produce the most desirable electrolyte phase.

Using one or more organic solvents in a solid-state electrolyte production process does produce a more homogenous mixture. However, the organic solvent may react with one or more precursor materials resulting in unwanted contaminates. Furthermore, if the organic solvent is insufficiently removed from the mixture, the solvent may form a chemical residue that may carbonize during a high-temperature heat treatment. These and other problems may be solved, alone or in combination, by various aspects of the present disclosure.

### Summary of Disclosure

Provided herein are methods for synthesizing a powder product for use in an electrochemical cell. The methods generally comprise combining at least one reactant with elemental sulfur in a molten state to produce a reactant slurry; and heating the reactant slurry to remove the elemental sulfur, thereby forming the powder product. In some embodiments, the at least one reactant comprises a lithium-containing material. In some aspects, the at least one reactant further comprises one or more phosphorus-containing material, sulfur-containing material, and halogen-containing material. In some embodiments, during the combining, the reactant slurry is heated to a temperature above 115° C. In some embodiments, during the heating, the reactant slurry is heated to a temperature from about 150° C. to about 1500° C. In some embodiments, the elemental sulfur and the at least one reactant are present in a volume ratio from about 1:99 to about 99:1. In some embodiments, the method further includes forming the reactant slurry into strings, films, filaments, rods, or droplets prior to heating the reactant slurry. In some aspects, the forming includes extrusion. In some other aspects, the forming includes atomization. In some embodiments, the powder product comprises a solid-state electrolyte. In some aspects, the solid-state electrolyte comprises a crystalline material, a glass material, or a glass ceramic material. In some embodiments, heating the reactant slurry is performed using a plasma source. In some embodiments, the elemental sulfur removed from the reactant slurry is in a vapor phase. In some aspects, the method further comprises collecting the removed elemental sulfur. In some aspects, the method further comprises condensing the removed elemental sulfur. In some further aspects, the method further includes further comprising recycling the condensed elemental sulfur.

Further provided herein are solid-state electrolytes produced by the methods described herein. In some embodiments, the solid-state electrolyte has a formula of Li⁺_{(12-n-w)}Bⁿ⁺X²_{6-w}Y^{-X}_{w}, wherein Bⁿ⁺ is P, As, Ge, Ga, Sb, Si, Sn, Al, In, Ti, V, Nb, or Ta; X²⁻ is S, Se, or Te; Y⁻ is Cl, Br, I, F, BH₄, BF₄, CN, OCN, SCN, or N₃; wherein x is any number from about 0 to about 1; wherein n is any number from about 3 to about 5; and wherein w is any number from about 0 to about 2. In some embodiments, the solid-state electrolyte has a formula of Li₇P₂S₈Cl, Li₇P₂S₈Br, Li₇P₂S₈I, Li₇P₂S₈Cl_{0.5}Br_{0.5}Li₃PS₄, Li₇P₃S₁₁, or Li₇PS₆. In some embodiments, the solid-state electrolyte has at least one crystalline phase or amorphous phase. In some embodiments, the solid-state electrolyte has a carbon content of 1 wt % or less.

Further provided herein are systems for synthesizing a powder product. The systems generally include a holding chamber to store elemental sulfur in a molten state; one or more reactant chambers to store one or more reactants, the one or more reactant chambers connected to the holding chamber such that the one or more reactants are combinable with the elemental sulfur to form a reactant slurry; a collection tank connected to the holding chamber and the one or more reactant chambers to receive the reactant slurry; and a plasma generator to generate a plasma in the collection tank such that the reactant slurry contacts the plasma, thereby vaporizing the elemental sulfur and forming the powder product. In some embodiments, the system further includes a distribution head connected to the collection tank for distributing the reactant slurry in the collection tank. In some aspects, the distribution head comprises an atomizer. In some aspects, the distribution head comprises an extruder. In some embodiments, the system further includes a condenser connected to the collection tank to condense the vaporized elemental sulfur. In some aspects, the condenser is connected to the holding chamber to recycle the condensed elemental sulfur.

### BRIEF DESCRIPTION OF THE FIGURES

FIG. 1 shows a diagram of a plasma system of the present disclosure for synthesizing solid-state electrolyte materials and precursors for solid-state electrolyte materials from solid reactants and precursors.

### DETAILED DESCRIPTION

Before aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/ml to about 80 mg/mL” should also be understood to provide support for the range of “50 mg/mL to 80 mg/mL.” The endpoint may also be based on the variability allowed by an appropriate regulatory body, such as the FDA, USP, etc.

As used herein in the specification and claims, unless clearly indicated to the contrary, the indefinite articles “a” and “an” should be understood to mean “at least one.”

In this disclosure, the terms “including,” “containing,” and/or “having” are understood to mean comprising, and are open ended terms.

As used herein, the term “electrolyte” refers to a complete material suitable for use as the electrolyte in an electrochemical device. A “solid electrolyte” refers to an electrolyte in the solid state, which is suitable for use in the same state. The solid electrolyte or electrolyte may be a pure, i.e., a single component material, with respect to both chemical composition, crystalline structure, and atomic structure, or it may contain a mixture of components having different chemical compositions, crystalline structures, and/or atomic structures.

As used herein, the term “composite” refers to a mixture of at least two components having distinct chemical compositions, crystalline structures, and/or atomic structures.

As used herein, the term “compound” refers to a component defined by a single chemical composition and a single crystalline structure.

As used herein, the term “elemental sulfur” refers to atomic sulfur as well as known sulfur allotropes, including but not limited to S₈, S₇, S₆, and polymorphs thereof.

As used herein, the term “reactant” refers to a material that is combined with elemental sulfur in the systems and methods described herein. Although some reactants may undergo chemical reactions in the systems and methods described herein, not all reactants will necessarily undergo a chemical reaction in the systems and methods described herein.

Described herein are systems and methods for producing solid-state electrolyte materials. The systems and methods use molten sulfur as a solvent to form a slurry as opposed to a hydrocarbon solvent. This produces a mixture of reactants and, ultimately, a solid-state electrolyte material that are devoid of any carbon residue or hydrocarbon solvent that may otherwise form or be left over when producing a solid-state electrolyte using a hydrocarbon solvent. The systems and methods, as well as the resulting solid-state electrolytes, are described in more detail below.

### I. System

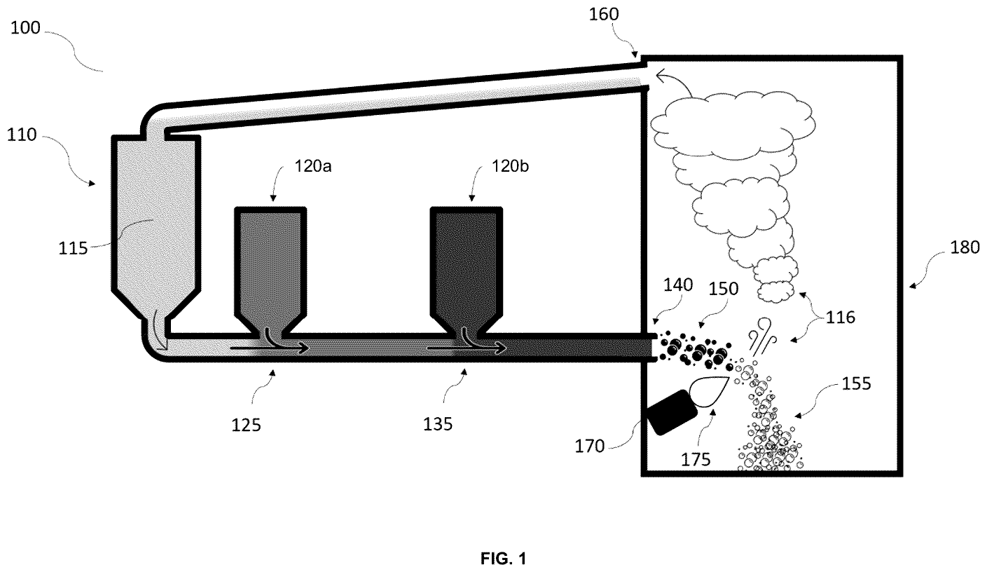

Referring to FIG. 1, a plasma system 100 for the production of powder materials for use in a solid-state electrochemical cell or in the manufacturing thereof is described herein.

The powder product material may include a solid electrolyte, an active material for an electrode, or a solid electrolyte precursor. The system 100 includes a holding chamber 110 connected to reactant chambers 120a, 120b to allow transfer of materials from the holding chamber 110 to the reactant chambers 120a, 120b. The holding chamber 110 and the reactant chambers 120a, 120b are connected to a distribution head 140, which feeds into a collection chamber 180.

Elemental sulfur in holding chamber 110 is heated above the melting point of sulfur to produce molten sulfur 115. The molten sulfur 115 is pumped to the distribution head 140. As the molten sulfur 115 moves towards the distribution head 140, reactant material contained in a first reactant chamber 120a is blended into the molten sulfur to form a reactant slurry 125. In some embodiments such as that shown in FIG. 1, this mixture may be pumped to a second reactant chamber 120b where additional reactant material may be blended into the reactant slurry 125, thereby forming a final slurry 135 containing molten sulfur and the reactant materials.

The final slurry 135 is then pumped into the collection chamber 180. In the system 100 shown in FIG. 1, the final slurry is pumped through the distribution head 140 into the collection chamber 180 where the final slurry 135 is distributed by extrusion or atomization to form droplets 150. The droplets 150 are heated by passing the final slurry 135 through a plasma 175 which is created by a plasma generator 170. As the droplets 150 are heated by the plasma 175, the molten sulfur evaporates to form sulfur vapor 116. The powder product 155 then collects at the bottom of the collection chamber 180. Sulfur vapor 116 is pulled into a collection area 160 where the sulfur vapor 116 is condensed into liquid sulfur. This liquid sulfur is then pumped into the holding chamber 110, where it may be recycled through the system 100.

In some embodiments, some components of the system 100 or all of the system 100 may be heated to a temperature above the melting point of sulfur, specifically above 100° C., or above 110° C., or above 120° C., to ensure that the sulfur remains in a molten state throughout the process.

The holding chamber 110, and the reactant chambers 120a, 120b, may be any storage vessel known in the art capable of storing molten sulfur and reactant materials. For example, the holding chamber 110 may be made from a ceramic such as alumina or zirconia, stainless steel, or high-temperature glass such as quartz. The holding chamber 110 may include a heating element, such as a steam jacket, to provide the heat necessary to maintain the sulfur in a molten state. The holding chamber 110 may have an inert atmosphere. The inert atmosphere may comprise or consist of nitrogen, argon, or another inert gas.

Although the system 100 shown in FIG. 1 contains two reactant chambers 120a, 120b, in some embodiments, the system may include only one reactant chamber or it may include three or more reactant chambers. Each reactant chamber is capable of storing one or more reactants. Each reactant chamber is further capable of dispensing the solid-state electrolyte precursor(s) into the molten sulfur to form a reactant slurry 125 or a final slurry 135. The reactant chamber is preferably equipped with sensors and mechanisms capable of controlling the mass flow rate of the solid-state electrolyte precursor(s) into the molten sulfur to control ratios of each reactant added to the reactant slurry 125 and the final slurry 135.

Each reactant chamber may include a blending apparatus (not shown) to blend the reactant contained in the reactant chamber with the molten sulfur. Blending apparatus may include a small tank with an agitator, such as a paddle stirrer, to thoroughly mix the solid-state electrolyte precursor and the molten sulfur. Other blending apparatuses known in the art may also be used.

Additionally or alternatively, each reactant chamber may a include milling or grinding apparatus (not shown) to reduce the particle size of the reactant before it is combined with the molten sulfur. The milling or grinding apparatus may include a ball mill, a high shear mixer, a compounding screw, or other milling and grinding apparatuses known in the art. In an embodiment, the milling or grinding apparatus includes a compounding screw.

The reactant contained in the reactant chambers 120a, 120b may include a solid electrolyte precursor. The solid electrolyte precursor may be used to form a solid electrolyte or to form other solid electrolyte precursors using the system 100. The solid electrolyte precursor may include a lithium-containing material, a phosphorus-containing material, a sulfur-containing material, a halogen-containing material, or any combination thereof. The lithium-containing precursor may include Li₂S, Li₂SO₄, LiOH, Li₂CO₃, Li₂O, Li₃PO₄, LiBO₂, Li₂B₄O₇, Li₂ZrO₃, LiAlO₂, Li₂TIO₃, LiNnO₃, and Li₂SiO₄, or a mixture thereof. other lithium-containing precursors known in the art, or any combination thereof. The phosphorus-containing precursor may include P₄S₄, P₄S₅, P₄S₆, P₄S₇, P₄S₈, P₄S₉, P₄S₁₀ (P₂S₅), P₃N₅, P₂O₅, P₄Sₓ where X is greater than 10, other phosphorus-containing precursors known in the art, or any combination thereof. The sulfur-containing precursor may include Na₂Sₓ, K₂Sₓ, Li₂Sₓ where 1≤X≤8, NaSH, LiSH, AS₂S₅, AS₂S₃, Sb₂S₅, Sb₂S₃, Al₂S₃, SiS₂, GeS₂, SnS₂, PbS₂, CoS₂, Co₃S₄, CrS, Cr₂S₃, Cr₃S₄, CuS, CuS₂, Cu₂S, FeS, FeS₂, Fe₃S₄, MnS, MnS₂, MoS₂, NiS, NiS₂, Ni₃S₂, ScS, SC₂S₃, SnS₂, TiS, TiS₂, Ti₂S₃, VS, VS₂, V₂S₃, VS₄, Y₂S₃, ZnS, ZrS₂, WS₂ or other sulfur-containing precursors known in the art, or any combination thereof. In some embodiments when the sulfur-containing precursor includes Na₂Sₓ, K₂Sₓ, or Li₂Sₓ, X may be 1<X<8; for example, X may be 2, 3, 4, 5, 6, or 7. The halogen-containing precursor may include a lithium halide, a sodium halide, a boron halide, an aluminum halide, a silicon halide, a phosphorus halide, a sulfur halide, a germanium halide, an arsenic halide, a selenium halide, a tin halide, an antimony halide, a tellurium halide, a lead halide, an yttrium halide, a magnesium halide, a bismuth halide, a zirconium halide, a lanthanum halide, a transition metal halide, or a lanthanide halide. In some additional embodiments, the halogen-containing precursor comprises LiF, LiCl, LiBr, Lil, NaF, NaCl, NaBr, Nal, BCl₃, BBr₃, Bl₃, AlF₃, AlBr₃, AlI₃, AlCl₃, SiF₄, SiCl₄, SiCl₃, Si₂Cl₅, SiBr₄, SiBrCl₃, SiBr₂Cl₂, SiI₄, PF₃, PF₅, PCl₃, PCl₅, POCl₃, PBr₃, POBr₃, Pl₃, P₂Cl₄, P₂I₄, SF₂, SF₄, SF₆, S₂F₁₀, SCl₂, S₂Cl₂, S₂Br₂, GeF₄, GeCl₄, GeBr₄, Gel₄, GeF₂, GeCl₂, GeBr₂, Gel₂, AsF₃, AsCl₃, AsBr₃, AsI₃, AsF₅, SeF₄, SeFe₆, SeCl₂, SeCl₄, Se₂Br₂, SeBr₄, SnF₄, SnCl₄, SnBr₄, SnI₄, SnF₂, SnCl₂, SnBr₂, SnI₂, SbF₃, SbCl₃, SbBr₃, SbI₃, SbF₅, SbCl₅, TeF₄, Te₂F₁₀, TeF₆, TeCl₂, TeCl₄, TeBr₂, TeBr₄, TeI₄, PbF₄, PbCl₄, PbF₂, PbCl₂, PbBr₂, PbI₂, YF₃, YCl₃, YBr₃, YI₃, MgF₂, MgCl₂, MgBr₂, MgI₂, BiF₃, BiCl₃, BiBr₃, BiI₃, ZrF₄, ZrCl₄, ZrBr₄, ZrI₄, LaF₃, LaCl₃, LaBr₃, LaI₃, LiF, LiCl, LiBr, Lil, LiClₓ Br_{y} where 0<x<1, 0<y<1, and where x+y=1, other halogen-containing precursors known in the art, or any combination thereof.

The reactant contained in the reactant chambers 120a, 120b may include reactants to produce an active material for use in an electrode of an electrochemical cell. Any one of the above-referenced reactants may be suitable for this purpose. For example, the reactant may include lithium metal, which may be used to produce Li₂S.

In some embodiments, the one or more reactants may undergo a chemical reaction with the molten sulfur when forming the powder product 155, thereby consuming some of the molten sulfur. Additional elemental sulfur may be added to the system 100 via a reactant chamber or by adding it to the holding chamber 110 from a separate vessel (not shown).

After mixing the reactant(s) with the molten sulfur 115 to form the final slurry 135, the ratio of elemental sulfur to the reactant(s) may be from about 1:99 to about 99:1 by volume. For example, the ratio of elemental sulfur to the reactant(s) may be from about 1:99 to about 1:75, about 1:99 to about 1:50, about 1:99 to about 1:25, about 1:99 to about 1:10, about 1:99 to about 1:5, about 1:99 to about 1:1, about 1:99 to about 5:1, about 1:99 to about 10:1, about 1:99 to about 25:1, about 1:99 to about 50:1, about 1:99 to about 75:1, about 1:99 to about 99:1, about 1:75 to about 99:1, about 1:50 to about 99:1, about 1:25 to about 99:1, about 1:10 to about 99:1, about 1:5 to about 99:1, about 1:1 to about 99:1, about 5:1 to about 99:1, about 10:1 to about 99:1, about 25:1 to about 99:1, about 50:1 to about 99:1, about 75:1 to about 99:1, about 1:75 to about 75:1, about 1:50 to about 50:1, about 1:25 to about 25:1, about 1:10 to about 10:1, or about 1:5 to about 5:1. As another example, the ratio of elemental sulfur to the reactant(s) may be about 1:99, 1:90, 1:80, 1:70, 1:60, 1:50, 1:40, 1:30, 1:20, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 20:1, 30:1, 40:1, 50:1, 60:1, 70:1, 80:1, 90:1, or about 99:1.

Alternatively, the ratio of elemental sulfur to the reactant(s) may be from about 1:99 to about 99:1 by weight. For example, the ratio of elemental sulfur to the reactant(s) may be from about 1:99 to about 1:75, about 1:99 to about 1:50, about 1:99 to about 1:25, about 1:99 to about 1:10, about 1:99 to about 1:5, about 1:99 to about 1:1, about 1:99 to about 5:1, about 1:99 to about 10:1, about 1:99 to about 25:1, about 1:99 to about 50:1, about 1:99 to about 75:1, about 1:99 to about 99:1, about 1:75 to about 99:1, about 1:50 to about 99:1, about 1:25 to about 99:1, about 1:10 to about 99:1, about 1:5 to about 99:1, about 1:1 to about 99:1, about 5:1 to about 99:1, about 10:1 to about 99:1, about 25:1 to about 99:1, about 50:1 to about 99:1, about 75:1 to about 99:1, about 1:75 to about 75:1, about 1:50 to about 50:1, about 1:25 to about 25:1, about 1:10 to about 10:1, or about 1:5 to about 5:1. As another example, the ratio of elemental sulfur to the reactant(s) may be about 1:99, 1:90, 1:80, 1:70, 1:60, 1:50, 1:40, 1:30, 1:20, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 20:1, 30:1, 40:1, 50:1, 60:1, 70:1, 80:1, 90:1, or about 99:1.

One or more pumps (not shown) may be used to transport the molten sulfur 115, the reactant slurry 125, and the final slurry 135 to the distribution head 140. The pumps may include piston pumps, centrifugal pumps, screw pumps, gear pumps, diaphragm pumps, positive-displacement pumps, axial-flow pumps, or any other pump known in the art capable of transporting the molten sulfur 115, the reactant slurry 125, and the final slurry 135. Alternatively, gravity may be used to direct the flow of molten sulfur 115 from the holding chamber 110 to the reactant chambers 120a, 120b and ultimately from the reactant chambers 120a, 120b to the distribution head 140.

The distribution head 140 may include an atomizer or an extruder to form the final slurry 135 into strings, films, filaments, rods, or, as shown in FIG. 1, droplets 150. Other shapes and forms of the mixture may be formed to increase the overall surface area of the final slurry 135, thereby allowing for more rapid vaporization of the molten sulfur in the final slurry 135. The atomizer may include an injector (pressure or gas-assisted), an ultrasonic nozzle, or other atomizers known in the art.

The plasma generator 170 includes an excitation source for excitation of a plasma gas. The plasma excitation source, for example, may include an AC discharge, a DC discharge, a laser discharge, a radio frequency (RF) source, a microwave (MW) source, other energy sources that may induce and/or support the plasma, or any combination thereof. The plasma 175 may be contained within a plasma flow reactor or other type of plasma system connected to the distribution head 140 and the collection chamber 180. In some embodiments, the plasma generator may be a plasma generator described in U.S. patent application Ser. No. 18/135,626 filed Apr. 17, 2023, the entire contents of which are incorporated by reference herein.

The powder product may be collected from the collection chamber 180 by filtration, electrostatic precipitation, or other mechanisms known in the art. Preferably, the temperature in the collection chamber 180 is high such that the vapor pressure of the sulfur is high enough that the sulfur evaporates or sublimates, thereby separating from the powder product 155. In some embodiments, the collection chamber 180 may have a temperature from about 115° C. to about 400° C., such as from about 210° C. to about 250° C. In some embodiments, all or substantially all of the sulfur (e.g., greater than 95% or greater than 99%) is removed from the powder product in the collection chamber 180. A small amount of unevaporated sulfur may be intentionally left in the powder product 155. The unevaporated sulfur may form a thin protective coating on the powder product 155.

When the sulfur vapor 116 vaporizes after the final slurry 135 passes through the plasma 175, the sulfur vapor 116 may be collected in a condenser (not shown). The condenser condenses the sulfur vapor 116 into molten sulfur 115. The molten sulfur 115 is then transferred to the holding tank 110 to be recycled through the system 100. The condenser operates at a temperature between the melting point and the boiling point of sulfur to condense the vapor-phase sulfur into a liquid. For example, the condenser may operate at a temperature from about 115° C. to about 400° C.

The resulting powder product 155 may be a solid-state electrolyte that may have at least one crystalline phase or at least one amorphous phase. Additionally, the solid-state electrolyte may include a glass material or a glass ceramic material.

The resulting powder product 155 may be a solid-state electrolyte that includes, but is not limited to, Li₆PS₅Cl, Li₆PS₅Br, Li₆PS₅Cl_{0.5}Br_{0.5}, Li₇P₂S₈Cl, Li₇P₂S₈Br, Li₇P₂S₆I, Li₇P₂S₈Cl_{0.5}Br_{0.5}, Li_{7-a-b}PS_{6-(a+b)}XₐY_{b} or Li₇P₂S₈XₐY_{b}, where X and Y includes a halogen, such as F, Cl, Br, or I or pseudohalogens, such as BH₄, BF₄, OCN, CN, SCN, SH, NO, or NO₂ where 0≤a≤2 and 0≤b≤2. In a further embodiment, resulting powder product may be an argyrodite-type electrolyte that satisfies Li⁺_{(12-n-w} Bⁿ⁺X²⁻_{6-w}Y^{-x}_{w}, wherein Bⁿ⁺ is P, As, Ge, Ga, Sb, Si, Sn, Al, In, Ti, V, Nb, or Ta; X²⁻ is S, Se, or Te; Y⁻ is Cl, Br, I, F, BH₄, BF₄, CN, OCN, SCN, or N₃; 0≤x≤1; 3≤n≤5; and 0≤w≤2.

In some embodiments, the resulting powder product 155 may include a solid-state electrolyte having the formula

Li_{(A)}M1_{(α)}M2_{(β)}P_{(B)}S_{(C)}X_{(D,}

where M1 and M2 each independently are an alkali metal such as Li, Na, K, Rb, or Cs, or an alkaline earth such as Be, Mg, Ca, Sr, or Ba; X is a halogen such as F, Cl, Br, or I; 2≤A≤9; 0≤a≤2; 0=β≤2; 1≤B≤3; 2≤C≤12; and 0≤D≤3. For example, A may be from about 2 to about 9, about 3 to about 8, about 4 to about 7, or about 5 to about 6. For example, B may be from about 1 to about 3, about 1.5 to about 2.5, or from about 2.0 to about 2.25. For example, a may be from about 0 to about 3, about 1 to about 2, or from about 1.5 to about 1.75. For example, B may be from about 0 to about 3, about 1 to about 2, or from about 1.5 to about 1.75. For example, C may be from about 2 to about 12, about 3 to about 11, about 4 to about 10, about 5 to about 9, about 6 to about 8, or about 6.5 to about 7.5. For example, D may be from about 0 to about 3, about 0.5 to about 2.5, about 1 to about 2.0, or from about 1.5 to about 1.7.

In some embodiments, the powder product 155 may include Li₃PS₄, Li₇PS₆, Li₇P₃S₁₁, Li₇P₂S₈X, Li₄PS₄X, Li₃P₃S₁₁X, Li₃M1αM2βPS₄, Li₃M1αM2βPS_{(4+β)}X_{(α)}, Li₇M1αM2βPS₆, Li₇M1αM2βP₃S₁₁X_{(α+β)}, Li₄M1αM2βPS₄X_{(1+α+β)}, Li₇M1αM2βPS₅X_{(1+α+β)}, or Li₇M1αM2βP₂S₈X_{(1+α+β)}, wherein 0≤a≤2 and 0≤β≤2.

Other examples of a solid-state electrolyte that may be produced in the system 100 include Li₃PS₄, Li₇P₃S₁₁, Li₇PS₆, Li₃BS₃, Li₂B₂S₅, Li₅B₇S₁₃, and Li₉B₁₉S₃₃.

The powder product 155 produced in the system 100 may have a carbon content of about 1 wt % or less. For example, the powder product may have a carbon content of about 1 wt % or less, about 0.5 wt % or less, about 0.01 wt % or less, or about 0.001 wt % or less. In some embodiments, the powder product 155 produced in the system 100 may be free of carbon.

The powder product 155 produced in the system 100 may have a surface that contains less than about 0.5 wt % carbon. For example, the surface of the powder product 155 may have a surface that contains less than about 0.5 wt % carbon, less than about 0.1 wt % carbon, less than about 0.01 wt % carbon, or less than about 0.001 wt % carbon. In some embodiments, the surface of the powder product 155 produced in the system 100 may be free of carbon.

The powder product 155 produced in the system 100 may include a sulfur-containing material for use as an electrolyte precursor. The sulfur-containing material may include alkali metal sulfide, such as Li₂S, Na₂S, K₂S, or any combination thereof. In another embodiment, the sulfur-containing material may include an alkaline earth metal sulfide such as BeS, MgS, CaS, SrS, BaS, or any combination thereof. In another embodiment, the sulfur-containing material may include a transition metal sulfide such as TiS₂, ZrS₂, WS₂, FeS₂, NiS₂, CuS₂, AgS, ZnS, or any combination thereof. In another embodiment, the sulfur-containing material may include a post-transition metal sulfide such as Al₂S₃, Ga₂S₃, SnS₂, Sn₂S₃, or any combination thereof. In another embodiment, the sulfur-containing material may include a metalloid sulfide such as B₂S₃, SiS₂, GeS₂, Sb₂S₃, Sb₂S₅, or any combination thereof. In preferred embodiments, the sulfur containing material may comprise or consist of Li₂S, GeS₂, SiS₂, or any combination thereof.

The powder product 155 produced in the system 100 may be an active material for use in an electrode of an electrochemical cell such as Li₂S.

### II. Methods

Further provided herein are methods for synthesizing powder products for use in solid-state electrochemical cells, such as solid-state electrolytes, electrolyte precursors, and active materials for use in electrodes. The methods may be performed using the systems described hereinabove. The method may include combining at least one reactant with molten elemental sulfur to produce a reactant slurry; and heating the reactant slurry to remove the elemental sulfur, thereby forming the product powder.

The method includes combining at least one reactant with molten elemental sulfur to produce a reactant slurry. Combining the at least one reactant with molten elemental sulfur may be accomplished by mixing the at least one reactant and the molten elemental sulfur using a blending apparatus as described above. The duration of mixing is not particularly so long as a homogeneous mixture of the at least one reactant and the molten elemental sulfur is formed. Combining the at least one reactant with molten elemental sulfur may further include grinding the at least one reactant to reduce the particle size of the at least one reactant before it is combined with the elemental sulfur. Those having ordinary skill in the art will understand that the combining step may be performed multiple times depending on how many reactants will be included in the solid-state electrolyte.

The at least one reactant may include any of the reactants described above in Section I.

The molten elemental sulfur and the at least one reactant may be combined in a volume ratio from about 1:99 to about 99:1. For example, the molten elemental sulfur and the at least one reactant may be combined in a volume ratio from about 1:99 to about 1:75, about 1:99 to about 1:50, about 1:99 to about 1:25, about 1:99 to about 1:10, about 1:99 to about 1:5, about 1:99 to about 1:1, about 1:99 to about 5:1, about 1:99 to about 10:1, about 1:99 to about 25:1, about 1:99 to about 50:1, about 1:99 to about 75:1, about 1:99 to about 99:1, about 1:75 to about 99:1, about 1:50 to about 99:1, about 1:25 to about 99:1, about 1:10 to about 99:1, about 1:5 to about 99:1, about 1:1 to about 99:1, about 5:1 to about 99:1, about 10:1 to about 99:1, about 25:1 to about 99:1, about 50:1 to about 99:1, about 75:1 to about 99:1, about 1:75 to about 75:1, about 1:50 to about 50:1, about 1:25 to about 25:1, about 1:10 to about 10:1, or about 1:5 to about 5:1. As another example, the molten elemental sulfur and the at least one reactant may be combined in a volume ratio of about 1:99, 1:90, 1:80, 1:70, 1:60, 1:50, 1:40, 1:30, 1:20, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 20:1, 30:1, 40:1, 50:1, 60:1, 70:1, 80:1, 90:1, or about 99:1.

The molten elemental sulfur and the at least one reactant may be combined in a mass ratio from about 1:99 to about 99:1. For example, the molten elemental sulfur and the at least one reactant may be combined in a mass ratio from about 1:99 to about 1:75, about 1:99 to about 1:50, about 1:99 to about 1:25, about 1:99 to about 1:10, about 1:99 to about 1:5, about 1:99 to about 1:1, about 1:99 to about 5:1, about 1:99 to about 10:1, about 1:99 to about 25:1, about 1:99 to about 50:1, about 1:99 to about 75:1, about 1:99 to about 99:1, about 1:75 to about 99:1, about 1:50 to about 99:1, about 1:25 to about 99:1, about 1:10 to about 99:1, about 1:5 to about 99:1, about 1:1 to about 99:1, about 5:1 to about 99:1, about 10:1 to about 99:1, about 25:1 to about 99:1, about 50:1 to about 99:1, about 75:1 to about 99:1, about 1:75 to about 75:1, about 1:50 to about 50:1, about 1:25 to about 25:1, about 1:10 to about 10:1, or about 1:5 to about 5:1. As another example, the molten elemental sulfur and the at least one reactant may be combined in a mass ratio of about 1:99, 1:90, 1:80, 1:70, 1:60, 1:50, 1:40, 1:30, 1:20, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 20:1, 30:1, 40:1, 50:1, 60:1, 70:1, 80:1, 90:1, or about 99:1.

During the combining step, the reactant slurry may be heated to a temperature of above 100° C. to maintain the elemental sulfur in a molten state. For example, the reactant slurry may be heated to a temperature of 100° C. or greater, 105° C. or greater, 110° C. or greater, 115° C. or greater, 120° C. or greater, 125° C. or greater, or 130° C. or greater. As another example, the reactant slurry may be heated to a temperature from about 100° C. to about 130° C., such as from about 110° C. to about 120° C.

The method further includes heating the reactant slurry to remove the elemental sulfur to form a powder product. Heating the reactant slurry to a temperature above the boiling point of the sulfur causes the molten elemental sulfur to vaporize and leave the reactant slurry. In embodiments wherein the powder product includes a solid-state electrolyte, the high temperatures also form the solid-state electrolyte, including crystalline and amorphous phases of the solid-state electrolyte.

The reactant slurry may be heated to a temperature from about 150° C. to about 1500° C. to remove the elemental sulfur as a vapor. For example, the reactant slurry may be heated to a temperature from about 150° C. to about 450° C., about 150° C. to about 750° C., about 150° C. to about 1050° C., about 150° C. to about 1350° C., about 150° C. to about 1500° C., about 450° C. to about 1500° C., about 750° C. to about 1500° C., about 1050° C. to about 1500° C., about 1350° C. to about 1500° C., about 300° C. to about 900° C., or about 500° C. to about 1000° C. As another example, the reactant slurry may be heated to a temperature of about 150° C., 200° C., 250° C., 300° C., 350° C., 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., or about 1500° C. In some embodiments, the reactant slurry may be heated using plasma.

The method may further include forming the reactant slurry into strings, films, filaments, rods, droplets, or other shapes. The forming may be accomplished through atomization, extrusion, or a combination thereof. The forming step, when conducted, occurs prior to heating the reactant slurry to remove the molten elemental sulfur.

The method may further comprise collecting the vaporized elemental sulfur removed from the reactant slurry. The vaporized elemental sulfur may be collected by condensing the vaporized elemental sulfur to form molten sulfur. The condensed molten sulfur may then be recycled and the methods described may be repeated using the recycled sulfur.

What is claimed is:

1. A method of synthesizing a powder product for use in an electrochemical cell comprising:
combining at least one reactant with elemental sulfur in a molten state to produce a reactant slurry; and
heating the reactant slurry to remove the elemental sulfur, thereby forming the powder product.

2. The method of claim 1, wherein the at least one reactant comprises a lithium-containing material.

3. The method of claim 2, wherein the at least one reactant further comprises one or more phosphorus-containing material, sulfur-containing material, and halogen-containing material.

4. The method of claim 1, wherein during the combining, the reactant slurry is heated to a temperature above 115° C.

5. The method of claim 1, wherein during the heating, the reactant slurry is heated to a temperature from about 150° C. to about 1500° C.

6. The method of claim 1, wherein the elemental sulfur and the at least one reactant are present in a volume ratio from about 1:99 to about 99:1.

7. The method of claim 1, further including forming the reactant slurry into strings, films, filaments, rods, or droplets prior to heating the reactant slurry.

8. The method of claim 7, wherein the forming includes extrusion.

9. The method of claim 7, wherein the forming includes atomization.

10. The method of claim 1, wherein the powder product comprises a solid-state electrolyte.

11. The method of claim 10, wherein the solid-state electrolyte comprises a crystalline material, a glass material, or a glass ceramic material.

12. The method of claim 1, wherein heating the reactant slurry is performed using a plasma source.

13. The method of claim 1, wherein the elemental sulfur removed from the reactant slurry is in a vapor phase.

14. The method of claim 13, further comprising collecting the removed elemental sulfur.

15. The method of claim 13, further comprising condensing the removed elemental sulfur.

16. The method of claim 15, further comprising recycling the condensed elemental sulfur.

17. A solid-state electrolyte produced by the method of claim 1.

18. A solid-state electrolyte produced by:
contacting at least one reactant with molten elemental sulfur;
mixing or grinding the at least one reactant with the molten elemental sulfur to produce a reactant slurry; and
heating the reactant slurry to remove the elemental sulfur, thereby forming a solid-state electrolyte.

19. The solid-state electrolyte material of claim 18, having a formula of Li⁺_{(12-n-w)}Bⁿ⁺X²⁻_{6-w}Y^{-X}_{w}, wherein Bⁿ⁺ is P, As, Ge, Ga, Sb, Si, Sn, Al, In, Ti, V, Nb, or Ta; X²⁻ is S, Se, or Te; Y⁻ is Cl, Br, I, F, BH₄, BF₄, CN, OCN, SCN, or N₃; wherein x is any number from about 0 to about 1; wherein n is any number from about 3 to about 5; and wherein w is any number from about 0 to about 2.

20. The solid-state electrolyte material of claim 18, having a formula of Li₇P₂S₈Cl, Li₇P₂S₈Br, Li₇P₂S₈I, Li₇P₂S₈Cl_{0.5}Br_{0.5}Li₃PS₄, Li₇P₃S₁₁, or Li₇PS₆.

21. The solid-state electrolyte material of claim 18, having at least one crystalline phase or amorphous phase.

22. The solid-state electrolyte material of claim 18, having a carbon content of 1 wt % or less.

23. A system for synthesizing a powder product comprising:
a holding chamber to store elemental sulfur in a molten state;
one or more reactant chambers to store one or more reactants, the one or more reactant chambers connected to the holding chamber such that the one or more reactants are combinable with the elemental sulfur to form a reactant slurry;
a collection tank connected to the holding chamber and the one or more reactant chambers to receive the reactant slurry; and
a plasma generator to generate a plasma in the collection tank such that the reactant slurry contacts the plasma, thereby vaporizing the elemental sulfur and forming the powder product.

24. The system of claim 23, further comprising a distribution head connected to the collection tank for distributing the reactant slurry in the collection tank.

25. The system of claim 24, wherein the distribution head comprises an atomizer.

26. The system of claim 24, wherein the distribution head comprises an extruder.

27. The system of claim 23, further comprising a condenser connected to the collection tank to condense the vaporized elemental sulfur.

28. The system of claim 27, wherein the condenser is connected to the holding chamber to recycle the condensed elemental sulfur.
